(19) United States
(12) Patent Application Publication
(10) Pub. No.: US 2026/0052569 A1
(43) Pub. Date: Feb. 19, 2026

(54) OVERLAPPING BASIC SERVICE SET BANDWIDTH DETERMINATION FOR NON-PRIMARY CHANNEL ACCESS

(71) Applicant: QUALCOMM Incorporated, San Diego, CA (US)

(72) Inventors: Gaurang NAIK, San Diego, CA (US); Alfred ASTERJADHI, San Diego, CA (US); Naveen Kumar KAKANI, Flower Mound, TX (US); Abhishek Pramod PATIL, San Diego, CA (US); George CHERIAN, San Diego, CA (US); Sai Yiu Duncan HO, San Diego, CA (US); Nandkishore PAI, Allen, TX (US); Madhusudhan Rao DARSIPUDI, Sunnyvale, CA (US); Jinsung LEE, San Jose, CA (US); Chao ZOU, San Jose, CA (US); Sabita NAHATA, Newark, CA (US); Giovanni CHISCI, San Diego, CA (US); Sanket Sanjay KALAMKAR, San Diego, CA (US); Sherief HELWA, San Diego, CA (US)

(21) Appl. No.: 18/809,174

(22) Filed: Aug. 19, 2024

(51) Int. Cl. H04W 74/0816; H04W 74/08

(52) U.S. Cl. CPC H04W 74/0816; H04W 74/0866

(57) ABSTRACT

This disclosure provides methods, components, devices and systems for overlapping basic service set (OBSS) bandwidth determination for non-primary channel access (NPCA). An example method, performed at a wireless node, generally includes detecting an overlapping basic service set (OBSS) transmission on a first primary channel, and performing one or more actions associated with a second primary channel, the performance being based on at least one rule and a result of an attempt to determine whether the OBSS transmission overlaps with the second primary channel, the overlap being associated with a bandwidth of the OBSS transmission.

### TECHNICAL FIELD

This disclosure relates generally to wireless communication, and more specifically, to techniques related to overlapping basic service set (OBSS) bandwidth determination for non-primary channel access (NPCA).

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods and devices of this disclosure each have several innovative aspects, no single one of which is solely responsible for the desirable attributes disclosed herein.

One innovative aspect of the subject matter described in this disclosure can be implemented in a method for wireless communication. The method includes detecting an OBSS transmission on a first primary channel and performing one or more actions associated with a second primary channel, the performance being based on at least one rule and a result of an attempt to determine whether the OBSS transmission overlaps with the second primary channel, the overlap being associated with a bandwidth of the OBSS transmission.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows a pictorial diagram of an example bandwidth configuration for a wireless local area network (WLAN).

FIGS. 3A and 3B show example bandwidth configurations and potential channel overlap.

FIGS. 4A and 4B show examples of transmitter and receiver radio resources assignment.

FIG. 5 shows example bandwidth signaling.

FIGS. 6A and 6B show examples of different types of OBSS transmit opportunities (TXOPs).

FIGS. 7A and 7B show different scenarios related to non-primary channel access.

FIG. 8 shows a flowchart illustrating example OBSS bandwidth determination rules, in accordance with certain aspects of the present disclosure.

FIGS. 9A and 9B show techniques/rules for determining O-Primary occupancy, in accordance with certain aspects of the present disclosure.

FIG. 10 shows example signaling for indicating a bandwidth configuration, in accordance with certain aspects of the present disclosure.

FIG. 11 shows a flowchart illustrating an example process performable by or at a wireless communication device (e.g., a STA or an AP) that supports techniques/rules for determining O-Primary occupancy, in accordance with certain aspects of the present disclosure.

FIG. 12 shows a block diagram of an example wireless communication device (e.g., a STA or an AP) that supports techniques/rules for determining O-Primary occupancy, in accordance with certain aspects of the present disclosure.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3^{rd} Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IOT) network.

Contention-based channel access generally refers to a mechanism used to share the wireless medium. Devices that want to transmit data first listen to the wireless channel. This procedure is referred to as carrier sensing, where a device first checks if the channel is idle or busy. If the channel is sensed as busy, indicating another device is currently transmitting, the carrier sensing device will wait for an idle period before attempting to transmit.

Contention-based channel access may be used to share access in WLANs that support relatively large bandwidths. For example, IEEE 802.11be Extremely High Throughput (EHT), also known as Wi-Fi 7, has defined bandwidth support for up to 320 MHz. Within the large bandwidth, one 20 MHz channel is designated as a primary channel.

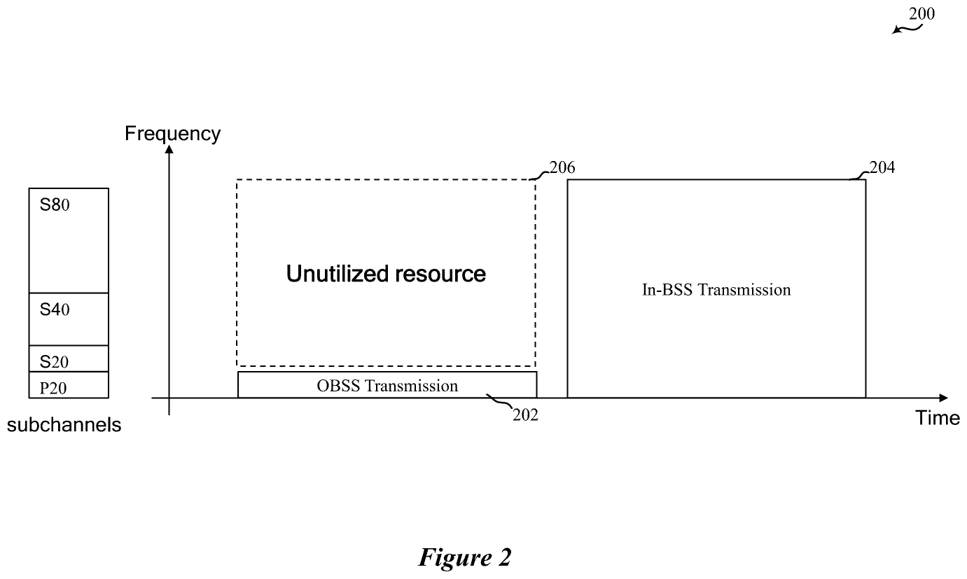

For example, FIG. 2 depicts a diagram 200 for an example bandwidth configuration for a 160 MHz bandwidth, in which the 20 MHz primary channel is labeled P20. A Wi-Fi device contends for access only on the primary channel and access to wider bandwidths (no matter how large) is contingent on access to the primary channel.

An NPCA STA may contend for access to, and transmit on, the O-Primary channel if certain conditions are met. For example, an NPCA STA may contend and transmit on a second primary channel (such as an Opportunistic Primary channel or O-Primary channel) if a main primary channel (M-Primary) (e.g., which may also be referred to as a primary channel or a primary 20 MHz channel) is occupied by OBSS traffic, and is, therefore, “busy,” and if the OBSS traffic occupying the M-Primary does not overlap with O-Primary (and is, therefore, “idle”). The O-Primary channel may also be referred to as an NPCA primary channel, an anchor primary channel, a temporary primary channel, and/or a backup primary channel.

For example, an NPCA STA may contend to transmit on O-Primary when M-Primary is busy, and the OBSS traffic occupying the M-Primary does not overlap with O-Primary, but may not contend to transmit on O-Primary when the OBSS traffic overlaps with O-Primary.

Thus, when an NPCA STA detects OBSS traffic on M-Primary, it may be beneficial to determine a bandwidth (BW) of the OBSS PPDU and whether the OBSS BW overlaps with the O-Primary channel.

In many PPDUs, certain wireless communications standards (e.g., IEEE 802.11) allow/require a transmitter to include an indication of bandwidth that the PPDU occupies. However, in certain cases, the signaling may be ambiguous and not sufficient to determine whether the PPDU overlaps with the O-Primary channel. Moreover, many STAs monitor for incoming PPDUs only on the 20 MHz M-Primary channel (as opposed to the entire PPDU BW). Also, due to limited BW of the NPCA STA, it may not be possible to measure the channel width that the PPDU occupies.

Aspects of the present disclosure provide techniques, rules, and guidelines for how an NPCA STA determines whether the OBSS PPDU occupies the O-Primary channel, when it is ambiguous whether the O-Primary is occupied, and/or what actions NPCA STAs can take to prevent performance degradation in the case of an ambiguity. It may be useful for certain wireless communications standards (e.g., IEEE 802.11) to define such techniques/rules/guidelines.

Particular aspects of the subject matter described in this disclosure can be implemented to realize one or more of the following potential advantages. In some examples, by utilizing rules, the bandwidth of an OBSS transmission may be determined, which may help a wireless node determine if or when to contend for access on an O-primary channel. As a result, the techniques proposed herein may help increase resource utilization, system performance, and overall user experience.

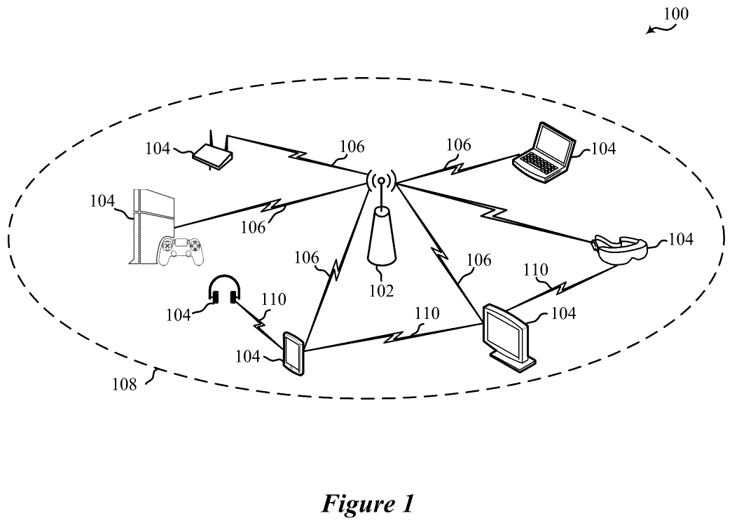

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (cNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IOT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an extended service set (ESS) including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or peer-to-peer (P2P) networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHz-52.6 GHZ), FR3 (7.125 GHz-24.25 GHZ), FR4a or FR4-1 (52.6 GHZ-71 GHZ), FR4 (52.6 GHz-114.25 GHZ), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHZ, 160 MHZ, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHZ channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel (e.g., which may also be referred to as a primary channel, a primary 20 MHz channel) and one or more additional, second primary channels may each be referred to as an opportunistic primary (O-Primary) channel (e.g., which may also be referred to as an NPCA primary, an anchor primary, a temporary primary, and/or a backup primary). For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, NPCA, and generally facilitating network management or optimizing network connections or characteristics to, for example, increase throughput or capacity, reduce latency or otherwise enhance user experience.

### Overview of Channel Numbering

A primary channel generally refers to a channel that a STA monitors for contention-based channel access. As described above with reference to FIG. 2, in WLANs that support relatively large bandwidths, one 20 MHz channel is designated as a primary channel. This channel may be referred to as primary 20 or, as labeled in FIG. 2, simply P20.

Selection of the bandwidth for the P20 channel typically decides all other channels. For example, in the case of a 160 MHz operating bandwidth, selection of P20 may determine a secondary 20 MHz channel (S20), a primary 40 MHz channel (P40), a secondary 40 MHz channel (S40), a primary 80 MHz channel (P80), and a secondary 80 MHz channel (S80).

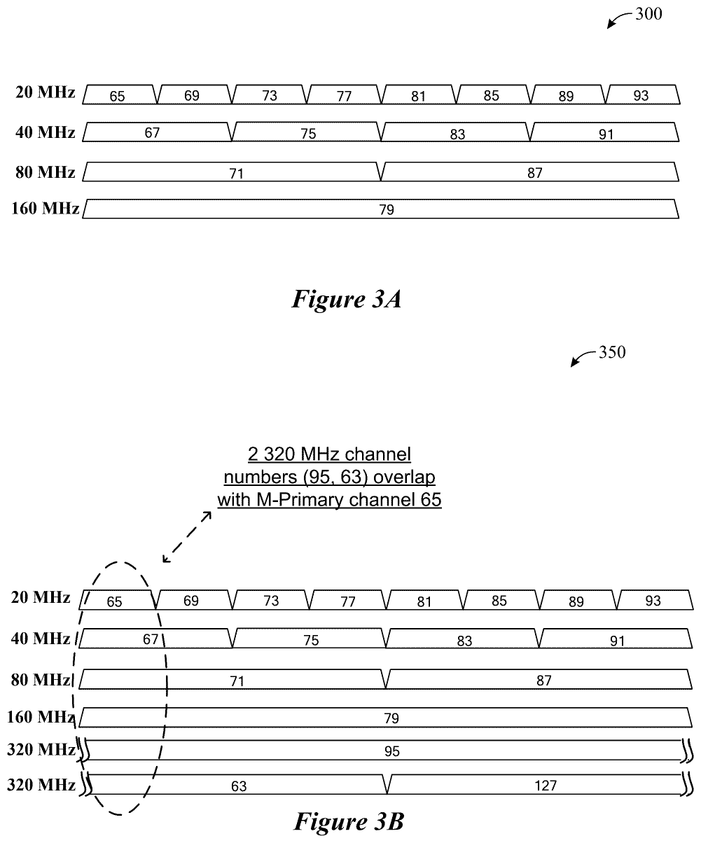

FIGS. 3A and 3B show an example of primary and secondary channel selection for a given channel. Diagram 300 of FIG. 3A shows how the bandwidth of a 160 MHz channel number 79 may be allocated to form different 80 MHz channels (71 and 87), 40 MHz channels (67, 75, 83, and 91), and 20 MHz channels (65, 69, 73, 77, 81, 85, 89, and 93). Particular channel frequencies for these channels may be determined based on a set of equations, determined by the operating bandwidth and a channel selection parameter X.

As illustrated in FIG. 3B, in some cases, there may also be multiple 320 MHz bandwidth configurations (which may be referred to as configurations 320-1 and 320-2). In the illustrated example, a (160 MHz) portion of 320 MHz channel 95 (of configuration 320-1) is shown and 80 MHz portions of 320 MHz channels 63 and 127 (of configuration 320-2) are shown.

As illustrated in FIG. 3A, assuming no 320 MHz operation, there may only be one channel number of a given channel width that overlaps with a given 20 MHz channel. As illustrated in FIG. 3B, with 320 MHz operation, 320 MHz channel 95 of configuration 320-1 and 320 MHz channel 63 of configuration 320-2 may overlap with 20 MHz channel 65.

### Overview of NPCA

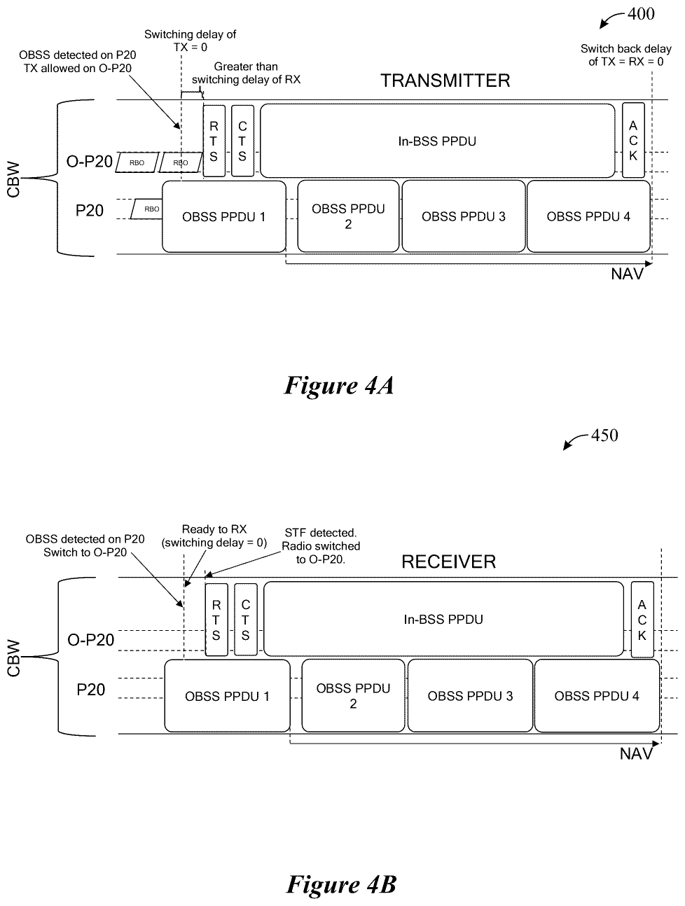

FIG. 4A shows a diagram 400 illustrating an example non-primary channel access (NPCA) STA in a scenario in which transmission is allowed on a non-primary channel (opportunistic primary channel O-P20).

In the illustrated example, while contending for channel access on a first (main) primary channel P20 to send a PPDU, the STA detects an OBSS transmission (PPDU) on P20 (during countdown of a random backoff (RBO) counter. In response, since transmission is allowed on O-P20, the STA switches to O-P20. After contending for (and gaining) access on O-P20, the STA sends an initial control frame (such as a trigger frame or a request to send (RTS)) and, after receiving the response to the initial control frame (such as a trigger response as a clear to send (CTS)), transmits its (In-BSS) PPDU. As illustrated, the intended recipient may send an acknowledgment (ACK) of receipt of the PPDU.

FIG. 4B shows a diagram 450 illustrating an example non-primary channel access (NPCA) STA in a scenario in which a STA switches to O-P20 for reception.

In the illustrated example, while contending for channel access on P20, the STA again detects an OBSS PPDU on P20. In response, the STA switches to O-P20 and, after a switching delay, is ready to receive on O-P20. After receiving an RTS on O-P20, the STA sends a CTS and receives a PPDU on O-P20. As illustrated, the STA may send an ACK after receiving the PPDU.

### Overview of Bandwidth Signaling

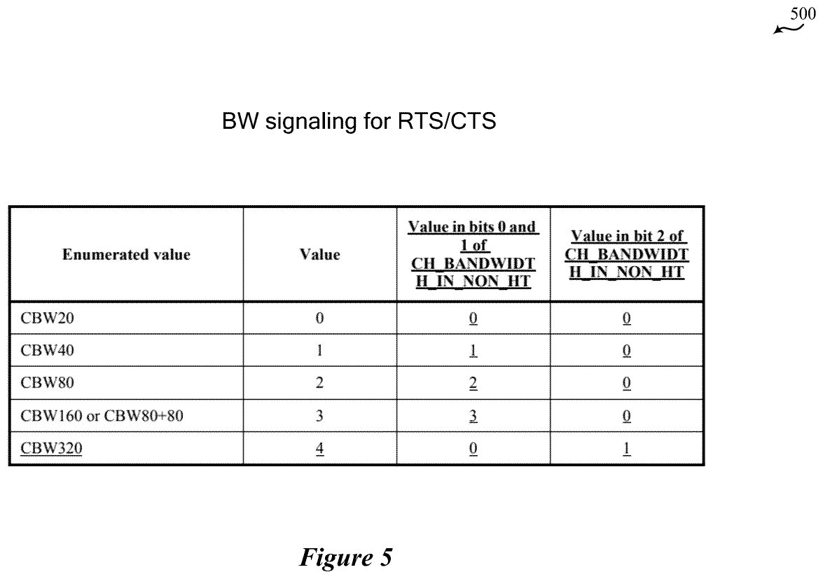

Certain 802.11 PPDUs carry an indication of the bandwidth occupied by the PPDU. As illustrated in FIG. 5, RTS and CTS frames may carry the bandwidth in the SERVICE field if transmitted by a VHT/HE/EHT STA. If RTS/CTS is used for BW negotiation, RTS and its corresponding CTS can indicate different BW. In such cases, the PPDU that follows the CTS frame may occupy the BW indicated in the CTS frame. In some cases, (such as when transmitted by an HT STA) the bandwidth may not be signaled.

In some cases, the PHY header of HE, EHT and UHR PPDUs may carry a bandwidth indication. For HE PPDU, this indication may be carried in the HE-SIG-A field. For EHT PPDU and UHR PPDU, this indication may be carried in the U-SIG field. In some cases, such signaling may be defined/mandated (e.g., for HE STAs and beyond) by certain wireless communication standards specifications.

### Overview of OBSS TXOPs

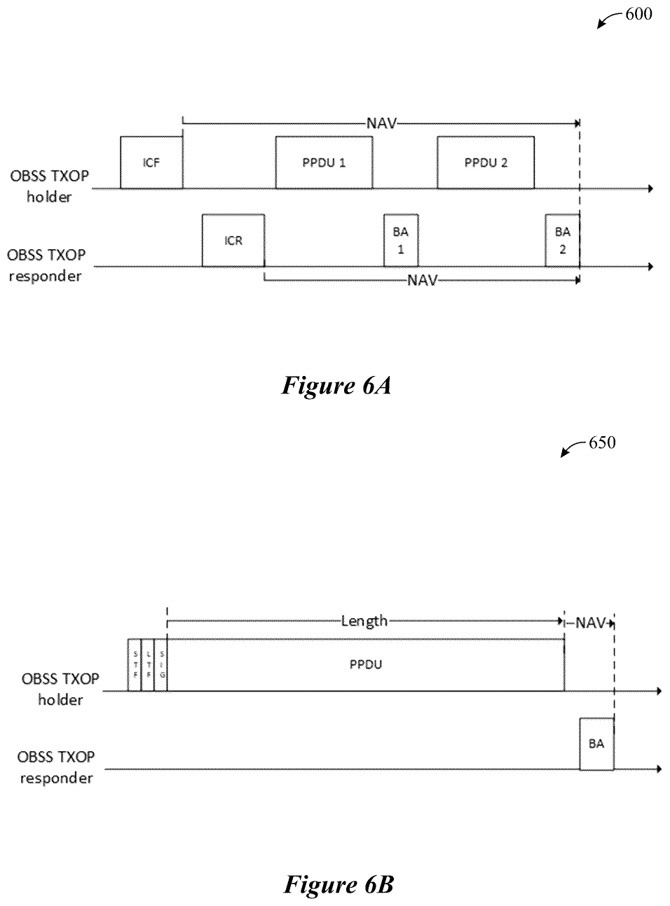

There are different scenarios for OBSS TXOPs. In a first scenario, a TXOP 600 begins with a control frame exchange (e.g., RTS/CTS or MU-RTS/CTS), as illustrated in FIG. 6A. As illustrated for example, the OBSS TXOP holder may transmit an initial control frame (ICF), and the OBSS TXOP responder may transmit, in response, an initial control response frame (ICR). This may be described as a control frame exchange. In a second scenario, a TXOP 650 begins without any control frame exchange, as illustrated in FIG. 6B.

In some cases, certain wireless communication standards (e.g., UHR) may allow NPCA operations when an OBSS TXOP is of Type 1, or if an OBSS TXOP is of Type 2 (e.g., if the PPDU is HE/EHT/UHR). This may be the case because the PPDU may be classified as inter-BSS without decoding the PSDU (e.g., decoding PHY header alone may be sufficient). The rules for determining the OBSS BW and whether it overlaps with O-Primary can be different based on the type of OBSS TXOPs.

### Aspects Related to OBSS Bandwidth Determination

As noted above, an NPCA STA may contend for access to, and transmit on, the O-Primary channel if certain conditions are met. For example, an NPCA STA may contend and transmit on the O-Primary channel if the M-Primary is occupied by OBSS traffic, and is, therefore, “busy,” or if the OBSS traffic occupying the M-Primary does not overlap with O-Primary.

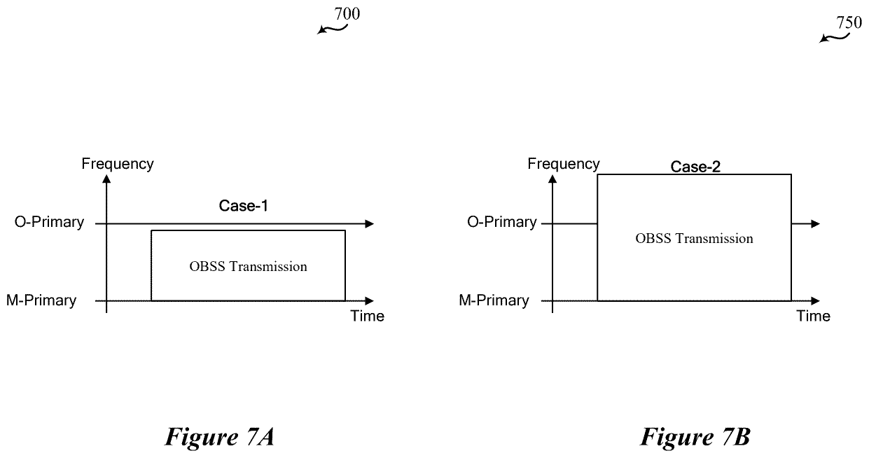

For example, an NPCA STA may contend to transmit on O-Primary in the scenario 700 illustrated in FIG. 7A (where M-Primary is busy, and the OBSS traffic occupying the M-Primary does not overlap with O-Primary), but not in the scenario 750 illustrated in FIG. 7B (e.g., where M-Primary is busy, and the OBSS traffic occupying the M-Primary does overlap with O-Primary).

Thus, when an NPCA STA detects OBSS traffic on M-Primary, it may need to determine a bandwidth (BW) of the OBSS PPDU. Based on this bandwidth determination, the NPCA STA may then determine whether the OBSS BW overlaps with the O-Primary channel and can decide whether or not to contend on the O-Primary.

In many PPDUs, certain wireless communications standards (e.g., IEEE 802.11) allow/require a transmitter to include an indication of bandwidth that the PPDU occupies. However, in certain cases, the signaling may be ambiguous and not sufficient to determine whether the PPDU overlaps with the O-Primary channel. Moreover, many STAs monitor for incoming PPDUs only on the 20 MHz M-Primary channel (as opposed to the entire PPDU BW). Also, due to limited BW of the NPCA STA, it may not be possible to measure the channel width that the PPDU occupies.

Aspects of the present disclosure provide mechanisms (e.g., based on rules and guidelines) for how an NPCA STA determines whether the OBSS PPDU occupies the O-Primary channel, when it is ambiguous whether the O-Primary is occupied, and/or what actions NPCA STAs can take to prevent performance degradation in the case of an ambiguity. It may be useful for certain wireless communications standards (e.g., IEEE 802.11) to define such techniques/rules/guidelines.

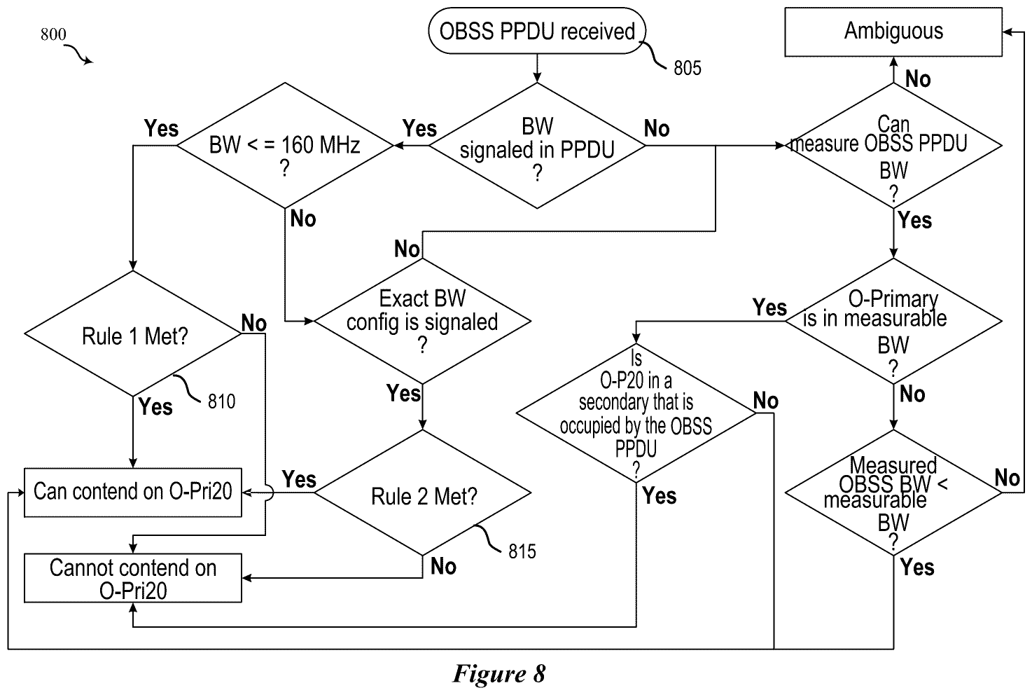

FIG. 8 shows a flowchart 800 illustrating example OBSS bandwidth determination rules, in accordance with certain aspects of the present disclosure. The scenarios and examples below may be followed by considering the different decision blocks and actions illustrated in FIG. 8 and how the following scenarios and examples traverse the flow diagram differently, resulting in different actions, after receiving/detecting an OBSS PPDU (at 805).

If the OBSS PPDU carries an indication of its bandwidth (as described with reference to FIG. 5) and is received by the NPCA STA on its M-Primary 20, and the indicated BW, X, is less than or equal to a threshold (e.g., 160 MHZ), then there can be only one X MHz-wide channel on which that PPDU is transmitted.

For example, referring again to FIG. 3A, if M-Primary20 is channel #77 and a PPDU is received that signals 160 MHz, then the PPDU is transmitted on channel #79. In some aspects, by inferring the X MHz-wide channel, it can be deterministically inferred/determined whether the X-MHz channel overlaps with the O-Primary20 channel. In some cases, the NPCA STA may only consider the BW signaling information received on its M-Primary20 channel.

In some aspects, when the signaled OBSS PPDU BW<=160 MHZ, the following rule/algorithm (e.g., Rule 1 in decision block 810 FIG. 8) may be utilized to determine whether an overlap exists (e.g., and/or whether to access O-Primary), as follows:

```
  If O-Primary20 is in SX, where X = {20, 40, 80, 160}:
    If OBSS PPDU BW <= X, Then: OBSS PPDU does not overlap with
O-Primary20 and can be accessed.
    Else: OBSS PPDU overlaps with O-Primary20 and cannot be
    accessed.
```

O-Primary20 is in SX implies that the STA's BSS is at least 2X-MHz wide. Thus, for example, if O-Primary20 is in S80, STA's BSS is at least 160 MHz wide. The location of O-Primary20 does not change frequently. Thus, if a current configuration has O-P20 in S80, then for any OBSS PPDU <=80 MHz, the O-P20 is Idle. The above rule may be applicable for both RTS/CTS and EHT/UHR/HE PPDU scenarios.

As described above with respect to FIG. 5, there may be two 320 MHz bandwidth configurations: 320 MHz-1 and 320 MHz-2. When the Bandwidth is signaled in an HE/EHT/UHR PPDU, the exact configuration may also be signaled. Thus, there may only be one unique 320 MHz channel of that configuration that overlaps with the M-Primary 20 of the NPCA STA, and by inferring the channel configuration. In such cases, a STA can deterministically infer/determine whether the 320-MHz channel overlaps with the O-Primary20 channel.

In some cases, an NPCA STA may only consider the BW signaling information received on its M-Primary20 channel. In some aspects, if the signaled OBSS PPDU BW==320 MHz, the following rule/algorithm (e.g., Rule 2 in decision block 815 FIG. 8) may be utilized to determine whether an overlap exists (e.g., and/or whether to access O-Primary), as follows:

```
If STA's BSS BW == 320 MHz AND STA's BSS configuration != OBSS
BW configuration AND O-Primary20 is in S160,
  Then: OBSS PPDU does not overlap with O-Primary20 and can be
  accessed.
Else: OBSS PPDU does overlap with O-Primary20 and cannot be
accessed.
```

Another scenario to consider is one in which the NPCA AP has setup its BSS on 320 MHz channel #95, where the M-Primary20 is channel #73 and O-Primary20 is channel #105 (M-Pri20 and O-Pri20 are in P160 & S160, respectively).

Possible NPCA STA behavior regarding BW determination and corresponding actions may be understood by considering a number of illustrative examples.

In a first example, the NPCA STA detects/sees OBSS EHT PPDU on its M-Primary20 that has BW=20 MHZ (B3-B5 of U-SIG-1 field set to 0). This may be the simplest case because it may be relatively straightforward to infer that OBSS occupies channel #73, and thus O-primary20 (channel #105) is IDLE and can be accessed.

In a second example, the NPCA STA detects/sees OBSS EHT PPDU on its M-Primary20 that has BW=40 MHz (B3-B5 of U-SIG-1 field set to 1). Since, the NPCA STA is receiving the PPDU on channel #73, the only 40 MHz channel that this PPDU can occupy is channel #75, and thus O-primary20 (channel #105) is IDLE and can be accessed.

In a third example, the NPCA STA detects OBSS EHT PPDU on its M-Primary20 that has BW=80 MHZ (B3-B5 of U-SIG-1 field set to 2). Since, the NPCA STA is receiving the PPDU on channel #73, the only 80 MHz channel that this PPDU can occupy is channel #71, and thus O-primary20 (channel #105) is IDLE and can be accessed.

In a fourth example, the NPCA STA detects OBSS EHT PPDU on its M-Primary20 that has BW=160 MHZ (B3-B5 of U-SIG-1 field set to 3). Since, the NPCA STA is receiving the PPDU on channel #73, the only 160 MHz channel that this PPDU can occupy is channel #79, and thus O-primary20 (channel #105) is IDLE and can be accessed.

In a fifth example, the NPCA STA detects OBSS EHT PPDU on its M-Primary20 that has BW=320 MHz-1 (B3-B5 of U-SIG-1 field set to 4). Based on channelization for 320 MHz channel (e.g., as defined in certain wireless communications standards-IEEE 802.11-36.3.24.2), since the NPCA STA is receiving the PPDU on channel #73, the PPDU is sent via channel #95. Thus O-primary20 (channel #105) is BUSY and cannot be accessed.

In a sixth example, the NPCA STA detects OBSS EHT PPDU on its M-Primary20 that has BW=320 MHz-2 (B3-B5 of U-SIG-1 field set to 5). Based on channelization for 320 MHz channel, since the NPCA STA is receiving the PPDU on channel #73, the PPDU is sent via channel #63. Thus, O-primary20 (channel #105) is IDLE and can be accessed.

Behavior of an NPCA STA in a scenario in which the NPCA AP has setup its BSS on 320 MHz channel #95, the M-Primary20 is channel #65 and O-Primary20 is channel #81 (M-Pri20 and O-Pri20 are in P80 & S80, respectively) may also be understood by considering a number of illustrative examples.

In a first example, the NPCA STA detects OBSS EHT PPDU on its M-Primary20 that has BW=20 MHZ (B3-B5 of U-SIG-1 field set to 0). This may be the simplest case because it may be relatively straightforward to infer that OBSS occupies channel #65, and thus O-primary20 (channel #81) is IDLE and can be accessed.

In a second example, the NPCA STA detects OBSS EHT PPDU on its M-Primary20 that has BW=40 MHZ (B3-B5 of U-SIG-1 field set to 1). Since the NPCA STA is receiving the PPDU on channel #65, the only 40 MHz channel that this PPDU can occupy is channel #67, and thus O-primary20 (channel #81) is IDLE and can be accessed.

In a third example, the NPCA STA detects OBSS EHT PPDU on its M-Primary20 that has BW=80 MHZ (B3-B5 of U-SIG-1 field set to 2). Since, the NPCA STA is receiving the PPDU on channel #65, the only 80 MHz channel that this PPDU can occupy is channel #71, and thus O-primary20 (channel #81) is IDLE and can be accessed.

In a fourth example, the NPCA STA detects OBSS EHT PPDU on its M-Primary20 that has BW=160 MHZ (B3-B5 of U-SIG-1 field set to 3). Since, the NPCA STA is receiving the PPDU on channel #65, the only 160 MHz channel that this PPDU can occupy is channel #79, and thus O-primary20 (channel #81) is BUSY and cannot be accessed.

In a fifth example, the NPCA STA detects OBSS EHT PPDU on its M-Primary20 that has BW=320 MHz-1 (B3-B5 of U-SIG-1 field set to 4). Based on channelization for a 320 MHz channel, since the NPCA STA is receiving the PPDU on channel #65, the PPDU is sent via channel #95. Thus, O-primary20 (channel #81) is BUSY and cannot be accessed.

In a sixth example, the NPCA STA detects OBSS EHT PPDU on its M-Primary20 that has BW=320 MHz-2 (B3-B5 of U-SIG-1 field set to 5). Based on channelization for a 320 MHz channel, since the NPCA STA is receiving the PPDU on channel #65, the PPDU is sent via channel #63. Thus, O-primary20 (channel #81) is BUSY and cannot be accessed.

As described with reference to FIG. 5, when a 320 MHz bandwidth is signaled in RTS/CTS frames, the exact configuration (e.g., 320 MHz-1 or 320 MHz-2) may not be indicated/signaled. Instead it may only be indicated/signaled that the bandwidth occupied by the PPDU is 320 MHz. As noted above, there are two configurations of 320 MHZ (320-1 and 320-2) in which a 320 MHz channel can overlap with a 20 MHz channel (e.g., both channel #63 and channel #95 overlap with 20 MHZ channel #77). As a consequence, it may be ambiguous/unclear as to whether the O-Primary channel is occupied. In some aspects, the NPCA STA may be capable of physically measuring the BW occupied by the OBSS PPDU (e.g., not relying on signaling alone). In such cases, it may be possible to resolve this ambiguity under certain conditions. Due to this ambiguity, further measures may be taken if the NPCA STA is to access the O-Primary channel.

In some implementations, a STA may be capable of physically measuring the OBSS PPDU BW. In such cases, the STA may be capable of inferring whether the O-Primary20 overlaps with the OBSS PPDU BW, even if the OBSS PPDU does not include any bandwidth signaling. Nevertheless, it may not be possible for the NPCA STA to deterministically determine whether the O-Primary20 overlaps with the OBSS PPDU or not. Inferring/determining whether O-Primary20 overlaps with the OBSS PPDU BW may be based on a rule/algorithm as follows:

```
  If measurable BW == 320 MHz, Then: O-Primary20 is within the
measurable BW, which may be equal to the STA's BW capability or less.
  If O-Primary20 is inside the measurable BW Y
    If O-Primary20 is within SX, where X = {20, 40, 80, 160}
      If OBSS PPDU <= X, Then: O-Primary20 is Idle and CAN be
accessed.
      Else: O-Primary20 is Busy and cannot be accessed.
  Elseif O-Primary20 is outside the measurable BW Y
    If the measured BW Z < Y, Then: O-Primary20 is Idle and can be
    accessed.
    Elseif Z == Y, Then: the inference/determination may be
ambiguous and further measures may be taken (as will be described in
greater detail below).
```

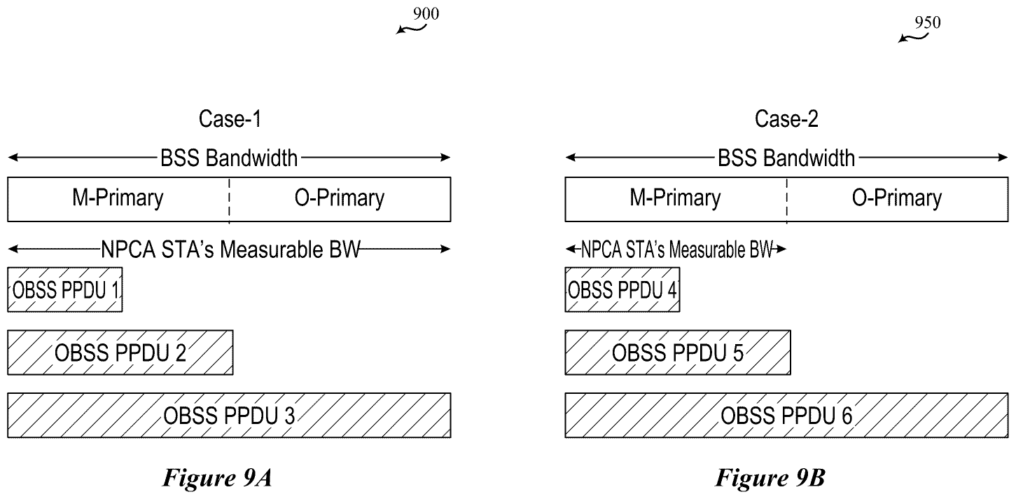

Certain aspects of the present disclosure provide techniques/rules for determining O-Primary occupancy (e.g., when OBSS Bandwidth is not signaled). Certain rules disclosed herein may be understood with reference to the different scenarios (Cases) illustrated in FIGS. 9A and 9B.

As illustrated in FIG. 9A, when O-Primary is inside/within the NPCA STA's measurable BW, it can easily determine whether the OBSS PPDU overlaps with O-Primary. For example, an NPCA STA can determine that OBSS PPDU 1 and OBSS PPDU 2 do not occupy O-Primary but OBSS PPDU 3 does.

As illustrated in FIG. 9B, when O-Primary is outside the NPCA STA's measurable BW, the determination may depend on OBSS PPDU BW. For example, the NPCA STA can determine that OBSS PPDU4 does not occupy O-Primary. For OBSS PPDU5, the NPCA STA can determine that the PPDU occupies its entire measurable BW, but may be unable to determine if the PPDU extends beyond its measurable BW. As a result, the NPCA STA may be unable to distinguish the BW of OBSS PPDU 5 and OBSS PPDU 6.

As noted above, there are certain scenarios in which an NPCA STA may be unable to unambiguously determine if an OBSS PPDU overlaps with O-Primary20. In such scenarios, the NPCA STA may perform one or more actions to address the ambiguity.

In some aspects, when the NPCA STA is unable to determine unambiguously if the OBSS PPDU overlaps with O-Primary20, the NPCA STA may be more conservative when it comes to access. In some aspects, for example, the NPCA STA may be overly conservative and refrain (e.g., be prohibited) from accessing the O-Primary20 altogether.

In some aspects, the NPCA STA may be allowed to access O-Primary20, but may initiate access based on an adjusted (e.g., reduced) energy detection (ED) threshold, so that it may detect OBSS PPDUs using ED with a higher probability. In some aspects, this reduced/lower ED threshold (e.g., −82 dBm) may be specified in certain wireless communications standards (e.g., IEEE) or may be specified by a wireless node (e.g., an AP device). For example, an ED value may be announced by an AP, and/or may be obtained by a STA by listening to beacons (or other frames) or during an association procedure.

In some cases, even though the initial frames in a TXOP may be ambiguous (e.g., in terms of OBSS BW/BW configuration), subsequent frames may provide an explicit indication of BW information (e.g., BW and/or BW configuration). For example, an OBSS TXOP may be initiated with RTS/CTS exchange, which signals 320 MHz BW but does not signal the exact BW configuration (e.g., 320 MHz-1 or 320 MHz-2). If O-Primary20 is in S160, the NPCA STA may be unable to determine, from the RTS/CTS signaling alone, whether the 320 MHz TXOP overlaps with O-Primary20. However, given that 320 MHz transmitter is an EHT STA or UHR STA, the subsequent PPDU (e.g., UHR PPDU, after CTS), may convey the exact BW configuration (e.g., 320 MHZ-1 or 320 MHz-2). Thus, in some aspects, the NPCA STA may wait/monitor (e.g., for a time duration, which may be configured, or until another or a next frame) until the signaling is decoded from the subsequent EHT/UHR PPDU. The NPCA STA may then determine whether to access O-P20. Similarly, if the OBSS TXOP does not include any signaling regarding the OBSS BW, then the NPCA STA may wait until a subsequent PPDU, indicating BW information, is received.

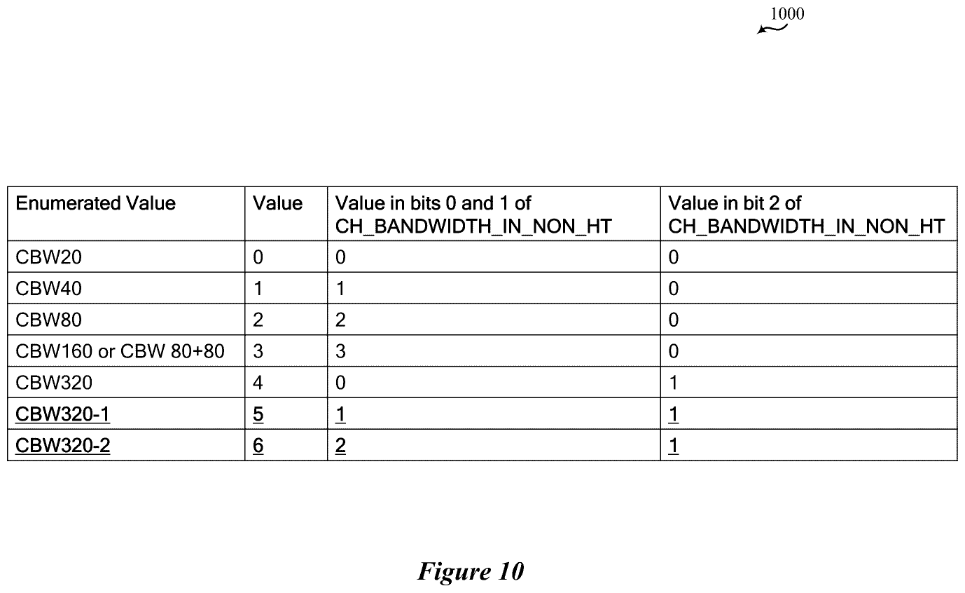

In the case of an exchange of RTS/CTS frames, there may be ambiguity for 320 MHz PPDUs because the exact BW configuration (e.g., a 320 MHz-1 or a 320 MHZ-2 configuration) is not signaled for EHT STAs. Aspects of the present disclosure, however, provides techniques for signaling enhancements (e.g., for UHR signaling) for RTS/CTS and non-HT PPDUs in general. For example, the signaling illustrated in FIG. 5 may be extended. For example, as illustrated in FIG. 10, the signaling may be extended to indicate a bandwidth configuration (e.g., a 320 MHz-1 or a 320 MHz-2 configuration and/or whether an OBSS PPDU is 80, 160, or 320 MHZ).

In some aspects, STAs operating in BSS with configuration 320 MHz-1 may transmit certain frames and STAs operating in BSS with configuration 320 MHz-2 may transmit other frames (e.g., and this may be defined in certain wireless communication standard specifications (UHR)). For example, a UHR specification may specify that 320 MHz-1 configuration STAs are to use RTS/CTS frames, whereas 320 MHz-2 configuration STAs are to use MU-RTS/CTS frames. Thus, if a STA detects an OBSS PPDU carrying an RTS frame signaling 320 MHz, it may infer that the UHR BSS is operating in 320 MHz-1 configuration.

In some aspects, an AP may (e.g., be in a better position to) determine the exact BW occupied by the OBSS PPDU. For example, the AP may be able to measure the exact BW occupied by OBSS STAs and determine whether the OBSS AP's BW overlaps with O-P20, even if the STAs may be unable to measure the BW.

In some aspects, the AP may build one or more lists (e.g., a list of OBSS APs that operate on a 320 MHz-1 configuration and a list of OBSS APs that operate on a 320 MHz-2 configuration), for example, by decoding the Beacon frames transmitted by the OBSS APs. The AP may announce the list(s) in Broadcast management frames (e.g., Beacon/Probe Response/Action frames. When an NPCA STA receives an RTS/CTS frame signaling 320 MHz, it may consult the list provided by the AP, and may identify whether the OBSS STA operates with a 320 MHz-1 or a 320 MHz-2 configuration, and may accordingly determine whether O-Primary20 can be accessed or not.

In some aspects, a STA may build/store list(s) of APs that operate on 320 MHz-1 and/or 320 MHz-2 configurations. For example, once the STA receives an EHT/UHR PPDU that signals the 320 MHz configuration, the STA may store a mapping (e.g., {BSS color: BW configuration}) in its local database. The next time the STA detects a PPDU with ambiguous signaling, it can consult the stored mapping to determine the BW configuration. In some aspects, certain wireless communications standards specifications (e.g., IEEE) may allow a STA to unambiguously use NPCA over an OBSS transmission if it has previous record of the OBSS operating on a certain 320 MHZ configuration.

Certain wireless communications standards specifications may specify a rule that dictates, for example, that “If an NPCA STA detects a 320 MHz inter-BSS PPDU and is unable to determine whether the NPCA Primary channel overlaps with the bandwidth occupied by the inter-BSS PPDU, the NPCA STA may access the medium as long as it uses dot11NPCAEDThreshold to contend for the medium, unless the NPCA STA has previously determined the bandwidth configuration of the BSS generating the inter-BSS PPDU.”

In some aspects, a STA may “learn” information related to 320 MHz-1 and/or 320 MHz-2 configurations based on (e.g., observed) statistical information. For example, a STA may learn that, in certain time intervals (e.g., TWT schedules) transmissions are always 80 MHz. In some aspects, a STA may derive bandwidth configurations that different OBSS wireless nodes operate on based on (e.g., observed) statistical information. In some aspects, a STA may leverage this information to determine the OBSS BW.

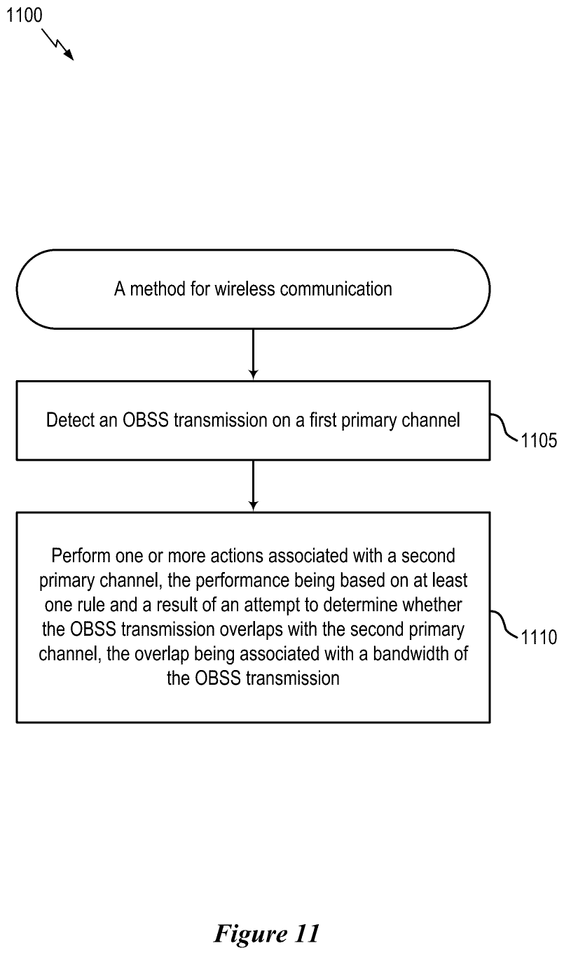

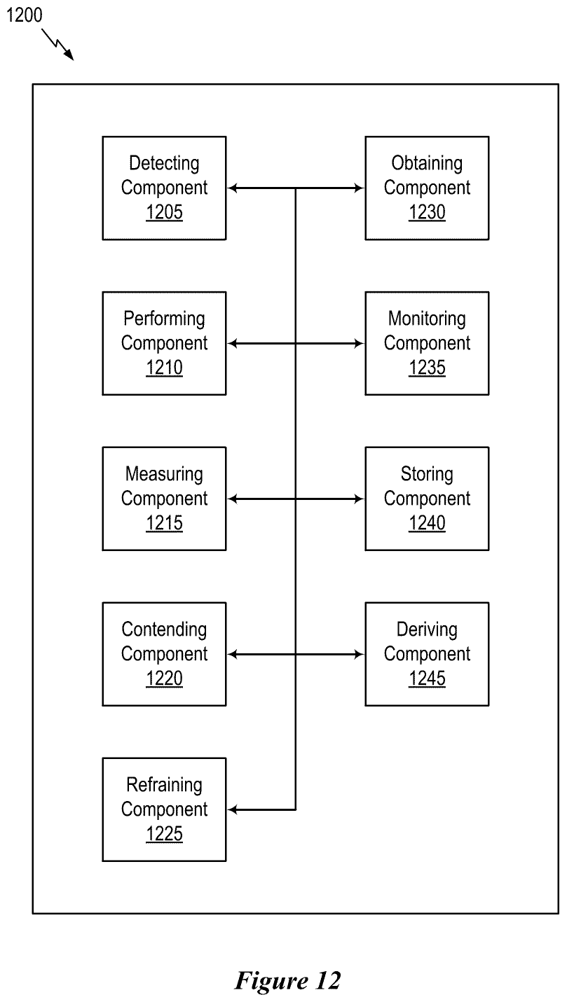

FIG. 11 shows a flowchart illustrating an example process 1100 performable by or at a wireless communication device. The operations of the process 1100 may be implemented by a wireless STA, or its components as described herein, and/or wireless AP, or its components as described herein. For example, the process 1100 may be performed by a wireless communication device, such as the wireless communication device 1200 described with reference to FIG. 12, operating as or within a wireless STA or operating as or within a wireless AP. In some examples, the process 1100 may be performed by a wireless STA such as one of the STAs 104 described with reference to FIG. 1. In some examples, the process 1100 may be performed by a wireless AP such as one of the APs 102 described with reference to FIG. 1.

In some examples, in block 1105, the wireless communication device may detect an OBSS transmission on a first primary channel. In some cases, the operations of this step refer to, or may be performed by, a detecting component as described with reference to FIG. 12.

In some examples, in block 1110, the wireless communication device may perform one or more actions associated with a second primary channel, the performance being based on at least one rule and a result of an attempt to determine whether the OBSS transmission overlaps with the second primary channel, the overlap being associated with a bandwidth of the OBSS transmission. In some cases, the operations of this step refer to, or may be performed by, a performing component as described with reference to FIG. 12.

In some aspects, the attempt is based on an indication, conveyed in the OBSS transmission, of the bandwidth of the OBSS transmission.

In some aspects, the attempt is further based on a bandwidth configuration of the OBSS transmission.

In some aspects, the process 1100 further includes measuring the bandwidth of the OBSS transmission, wherein the attempt is based on the measured bandwidth. In some cases, the operations of this step refer to, or may be performed by, a measuring component as described with reference to FIG. 12.

In some aspects, the result indicates that the OBSS transmission does not overlap with the second primary channel, and performing the one or more actions comprises contending for access to the second primary channel.

In some aspects, the result indicates that the OBSS transmission does overlap with the second primary channel, and performing the one or more actions comprises refraining, for a time duration, from contending for access to the second primary channel.

In some aspects, the OBSS transmission comprises a frame that is part of a control frame exchange.

In some aspects, the first primary channel comprises a main primary channel; and the second primary channel comprises an opportunistic primary channel.

In some aspects, the result is inconclusive regarding whether the OBSS transmission overlaps with the second primary channel, and performing the one or more actions comprises: contending for access to the second primary channel, or refraining, for a time duration, from contending for access to the second primary channel.

In some aspects, the contention is based on a first ED threshold; and the first ED threshold is lower than a second ED threshold used for contention when the result indicates the OBSS transmission does not overlap with the second primary channel.

In some aspects, the process 1100 further includes obtaining the first ED threshold from a wireless node. In some cases, the operations of this step refer to, or may be performed by, an obtaining component as described with reference to FIG. 12.

In some aspects, the result is inconclusive regarding whether the OBSS transmission overlaps with the second primary channel, and performing the one or more actions comprises monitoring for signaling that conclusively indicates whether the OBSS transmission overlaps with the second primary channel.

In some aspects, the OBSS transmission comprises a frame that is part of a control frame exchange; and the attempt is further based on a bandwidth configuration conveyed in the frame of the OBSS transmission.

In some aspects, the process 1100 further includes obtaining information regarding bandwidth configurations that different OBSS wireless nodes operate on, wherein the attempt is further based on the information. In some cases, the operations of this step refer to, or may be performed by, an obtaining component as described with reference to FIG. 12.

In some aspects, the process 1100 further includes storing information regarding bandwidth configurations that different OBSS wireless nodes operate on, wherein the attempt is further based on the stored information. In some cases, the operations of this step refer to, or may be performed by, a storing component as described with reference to FIG. 12.

In some aspects, the process 1100 further includes deriving, based on statistical information, information regarding one or more bandwidth configurations that different OBSS wireless nodes operate on, wherein the attempt is further based on the derived information. In some cases, the operations of this step refer to, or may be performed by, a deriving component as described with reference to FIG. 12.

Note that FIG. 11 is just one example of a process, and other processes including fewer, additional, or alternative steps are possible consistent with this disclosure.

FIG. 12 shows a block diagram of an example wireless communication device 1200. In some examples, the wireless communication device 1200 is configured to perform the process 1100 described with reference to FIG. 11. The wireless communication device 1200 may include one or more chips, SoCs, chipsets, packages, components or devices that individually or collectively constitute or include a processing system. The processing system may interface with other components of the wireless communication device 1200, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the device 1200 may transmit the information output from the chip. In such an example, the second interface may refer to an interface between the processing system of the chip and a reception component, such that the device 1200 may receive information that is passed to the processing system. In some such examples, the first interface also may obtain information, such as from the transmission component, and the second interface also may output information, such as to the reception component.

The processing system of the wireless communication device 1200 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 1200 can be configurable or configured for use in an AP, such as the AP 102 described with reference to FIG. 1. In some other examples, the wireless communication device 1200 can be an AP that includes such a processing system and other components including multiple antennas. The wireless communication device 1200 is capable of transmitting and receiving wireless communications in the form of, for example, wireless packets. For example, the wireless communication device 1200 can be configurable or configured to transmit and receive packets in the form of physical layer PPDUs and MPDUs conforming to one or more of the IEEE 802.11 family of wireless communication protocol standards. In some other examples, the wireless communication device 1200 can be configurable or configured to transmit and receive signals and communications conforming to one or more 3GPP specifications including those for 5G NR or 6G. In some examples, the wireless communication device 1200 also includes or can be coupled with one or more application processors which may be further coupled with one or more other memories. In some examples, the wireless communication device 1200 further includes at least one external network interface coupled with the processing system that enables communication with a core network or backhaul network that enables the wireless communication device 1200 to gain access to external networks including the Internet.

The wireless communication device 1200 includes detecting component 1205, performing component 1210, measuring component 1215, obtaining component 1220, storing component 1225, and deriving component 1230. Portions of one or more of the components 1205, 1210, 1215, 1220, 1225, and 1230 may be implemented at least in part in hardware or firmware. For example one or more of the components 1205, 1210, 1215, 1220, 1225, and 1230 may be implemented at least in part by a processor or a modem. In some examples, portions of one or more of the components 1205, 1210, 1215, 1220, 1225, and 1230 may be implemented at least in part by a processor and software in the form of processor-executable code stored in a memory.

Implementation examples are described in the following numbered clauses:

Clause 1: A method for wireless communication at a wireless node, including: detecting an OBSS transmission on a first primary channel; and performing one or more actions associated with a second primary channel, the performance being based on at least one rule and a result of an attempt to determine whether the OBSS transmission overlaps with the second primary channel, the overlap being associated with a bandwidth of the OBSS transmission.

Clause 2: The method of Clause 1, where the attempt is based on an indication, conveyed in the OBSS transmission, of the bandwidth of the OBSS transmission.

Clause 3: The method any one of Clauses 1-2, where the attempt is further based on a bandwidth configuration of the OBSS transmission.

Clause 4: The method any one of Clauses 1-3, further including: measuring the bandwidth of the OBSS transmission, wherein the attempt is based on the measured bandwidth.

Clause 5: The method any one of Clauses 1-4, where the result indicates that the OBSS transmission does not overlap with the second primary channel, and performing the one or more actions includes contending for access to the second primary channel.

Clause 6: The method any one of Clauses 1-5, where the result indicates that the OBSS transmission does overlap with the second primary channel, and performing the one or more actions includes refraining, for a time duration, from contending for access to the second primary channel.

Clause 7: The method any one of Clauses 1-6, where the OBSS transmission includes a frame that is part of a control frame exchange.

Clause 8: The method any one of Clauses 1-7, where the first primary channel includes a main primary channel; and the second primary channel includes an opportunistic primary channel.

Clause 9: The method any one of Clauses 1-8, where the result is inconclusive regarding whether the OBSS transmission overlaps with the second primary channel, and performing the one or more actions includes: contending for access to the second primary channel, or refraining, for a time duration, from contending for access to the second primary channel.

Clause 10: The method of Clause 9, where the contention is based on a first ED threshold; and the first ED threshold is lower than a second ED threshold used for contention when the result indicates the OBSS transmission does not overlap with the second primary channel.

Clause 11: The method of Clause 10, further including: obtaining the first ED threshold from a wireless node.

Clause 12: The method any one of Clauses 1-11, where the result is inconclusive regarding whether the OBSS transmission overlaps with the second primary channel, and performing the one or more actions includes monitoring for signaling that conclusively indicates whether the OBSS transmission overlaps with the second primary channel.

Clause 13: The method any one of Clauses 1-12, where the OBSS transmission includes a frame that is part of a control frame exchange; and the attempt is further based on a bandwidth configuration conveyed in the frame of the OBSS transmission.

Clause 14: The method any one of Clauses 1-13, further including: obtaining information regarding bandwidth configurations that different OBSS wireless nodes operate on, wherein the attempt is further based on the information.

Clause 15: The method any one of Clauses 1-14, further including: storing information regarding bandwidth configurations that different OBSS wireless nodes operate on, wherein the attempt is further based on the stored information.

Clause 16: The method any one of Clauses 1-15, further including: deriving, based on statistical information, information regarding one or more bandwidth configurations that different OBSS wireless nodes operate on, wherein the attempt is further based on the derived information.

Clause 17: An apparatus, including: at least one memory including executable instructions; and at least one processor configured to execute the executable instructions and cause the apparatus to perform a method in accordance with any combination of Clauses 1-16.

Clause 18: An apparatus, including means for performing a method in accordance with any combination of Clauses 1-16.

Clause 19: A non-transitory computer-readable medium including executable instructions that, when executed by at least one processor of an apparatus, cause the apparatus to perform a method in accordance with any combination of Clauses 1-16.

Clause 20: A computer program product embodied on a computer-readable storage medium including code for performing a method in accordance with any combination of Clauses 1-16.

Clause 21: A wireless node (e.g., an AP-STA or non-AP STA), comprising: at least one transceiver; at least one memory comprising instructions; and one or more processors, individually or collectively, configured to execute the instructions and cause the wireless node to perform a method in accordance with any one of clauses 1-16, wherein the at least one transceiver is configured to receive the OBSS transmission.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of”′ a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

Further, while the present disclosure may describe certain types of communications between different types of wireless nodes (e.g., between an AP STA and a non-AP STA), the same or similar types of communications may occur between same types of wireless nodes (e.g., between AP STAs or between non-AP STAs, in a peer-to-peer scenario). Further, communications may occur in reverse order than described.

Means for detecting, means for performing, means for measuring, means for contending, means for refraining, means for monitoring, means for storing, means for deriving, means for outputting, and means for obtaining may comprise one or more processors, such as one or more of the processors described above with reference to FIG. 11.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. An apparatus for wireless communication, comprising:
at least one memory comprising computer-executable instructions; and
one or more processors configured to execute the computer-executable instructions and cause the apparatus to:
detect an overlapping basic service set (OBSS) transmission on a first primary channel; and
perform one or more actions associated with a second primary channel, the performance being based on at least one rule and a result of an attempt to determine whether the OBSS transmission overlaps with the second primary channel, the overlap being associated with a bandwidth of the OBSS transmission.

2. The apparatus of claim 1, wherein the attempt is based on an indication, conveyed in the OBSS transmission, of the bandwidth of the OBSS transmission.

3. The apparatus of claim 1, wherein the attempt is further based on a bandwidth configuration of the OBSS transmission.

4. The apparatus of claim 1, wherein the one or more processors are further configured to cause the apparatus to:
measure the bandwidth of the OBSS transmission,
wherein the attempt is based on the measured bandwidth.

5. The apparatus of claim 1, wherein:
the result indicates that the OBSS transmission does not overlap with the second primary channel, and
in order to perform the one or more actions, the one or more processors are further configured to cause the apparatus to contend for access to the second primary channel.

6. The apparatus of claim 1, wherein:
the result indicates that the OBSS transmission does overlap with the second primary channel, and
in order to perform the one or more actions, the one or more processors are further configured to cause the apparatus to refrain, for a time duration, from contending for access to the second primary channel.

7. The apparatus of claim 1, wherein the OBSS transmission comprises a frame that is part of a control frame exchange.

8. The apparatus of claim 1, wherein:
the first primary channel comprises a main primary channel; and
the second primary channel comprises an opportunistic primary channel.

9. The apparatus of claim 1, wherein:
the result is inconclusive regarding whether the OBSS transmission overlaps with the second primary channel, and
in order to perform the one or more actions, the one or more processors are further configured to cause the apparatus to contend for access to the second primary channel or refraining, for a time duration, from contending for access to the second primary channel.

10. The apparatus of claim 9, wherein:
the contention is based on a first energy detection (ED) threshold; and
the first ED threshold is lower than a second ED threshold used for contention when the result indicates the OBSS transmission does not overlap with the second primary channel.

11. The apparatus of claim 10, wherein the one or more processors are further configured to cause the apparatus to obtain the first ED threshold from a wireless node.

12. The apparatus of claim 1, wherein:
the result is inconclusive regarding whether the OBSS transmission overlaps with the second primary channel, and
in order to perform the one or more actions, the one or more processors are further configured to cause the apparatus to monitor for signaling that conclusively indicates whether the OBSS transmission overlaps with the second primary channel.

13. The apparatus of claim 1, wherein:
the OBSS transmission comprises a frame that is part of a control frame exchange; and
the attempt is further based on a bandwidth configuration conveyed in the frame of the OBSS transmission.

14. The apparatus of claim 1, wherein the one or more processors are further configured to cause the apparatus to:
obtain information regarding bandwidth configurations that different OBSS wireless nodes operate on, wherein the attempt is further based on the information.

15. The apparatus of claim 1, wherein the one or more processors are further configured to cause the apparatus to:
store information regarding bandwidth configurations that different OBSS wireless nodes operate on, wherein the attempt is further based on the stored information.

16. The apparatus of claim 1, wherein the one or more processors are further configured to cause the apparatus to:
derive, based on statistical information, one or more bandwidth configurations that different OBSS wireless nodes operate on, wherein the attempt is further based on the derived information.

17. A method for wireless communication at a wireless node, comprising:
detecting an OBSS transmission on a first primary channel; and
performing one or more actions associated with a second primary channel, the performance being based on at least one rule and a result of an attempt to determine whether the OBSS transmission overlaps with the second primary channel, the overlap being associated with a bandwidth of the OBSS transmission.

18. The method of claim 17, wherein the attempt is based on an indication, conveyed in the OBSS transmission, of the bandwidth of the OBSS transmission.

19. The method of claim 17, wherein the attempt is further based on a bandwidth configuration of the OBSS transmission.

20. A wireless station, comprising:
at least one transceiver;
at least one memory comprising computer-executable instructions; and
one or more processors configured to execute the computer-executable instructions and cause the wireless station to:
detect, via the at least one transceiver, an overlapping basic service set (OBSS) transmission on a first primary channel; and
perform one or more actions associated with a second primary channel, the performance being based on at least one rule and a result of an attempt to determine whether the OBSS transmission overlaps with the second primary channel, the overlap being associated with a bandwidth of the OBSS transmission.
